(19) United States
(12) Patent Application Publication
(10) Pub. No.: US 2023/0360566 A1
(43) Pub. Date: Nov. 9, 2023

(54) DISPLAY BRIGHTNESS AND REFRESH RATE THROTTLING AND MULTI-VIEW IMAGE FUSION

(71) Applicant: META PLATFORMS, INC., Menlo Park, CA (US)

(72) Inventors: Suhas Gupta, San Jose, CA (US); Raunaq Naidu, San Jose, CA (US); Zhaonian Zhang, Sunnyvale, CA (US); Scott Jeffrey Woltman, Seattle, WA (US); Joshua Miller, Woodinville, CA (US); Sebastian Sztuk, Virum (DK); Gabriel Molina, Sunnyvale, CA (US); Josiah Vincent Vivona, San Diego, CA (US); Varun Nasery, Sunnyvale, CA (US); Xiaofei Ma, San Ramon, CA (US); Nan Jiang, Palo Alto, CA (US)

(21) Appl. No.: 18/136,246

(22) Filed: Apr. 18, 2023

Related U.S. Application Data
(60) Provisional application No. 63/351,143, filed on Jun. 10, 2022.
(60) Provisional application No. 63/338,615, filed on May 5, 2022.

(51) Int. Cl. G09G 3/00; H04N 23/45; H04N 23/698; H04N 5/265

(52) U.S. Cl. CPC G09G 3/001; G09G 3/006; H04N 5/265; H04N 23/45; H04N 23/698; G09G 2320/0247; G09G 2320/041; G09G 2320/0626; G09G 2330/021; G09G 2340/0435

(57) ABSTRACT

Methods and systems for adjusting device functions based on ambient conditions or battery status are disclosed. When environmental or device conditions reach a threshold level, device function such as display brightness or display refresh rate may be adjusted. One such example, may include a method and system for image fusion with a wide camera and a second image from a narrow camera to create a composite image with unnoticeable blending between the images.

### CROSS-REFERENCE TO RELATED APPLICATIONS

This application claims the benefit of U.S. Provisional Pat. Applications Nos. 63/338,615, filed May 5, 2022, entitled “Display Brightness And Refresh Rate Throttling Based On Ambient And System Temperature, And Battery Status” and 63/351,143, filed Jun. 10, 2022, entitled “Multi-View Image Fusion,” the entire content of which is incorporated herein by reference.

### TECHNOLOGICAL FIELD

The present disclosure generally relates to methods, apparatuses, or computer program products for adjusting device functions based on ambient conditions or battery status, and video recording using cameras wherein multiple cameras share a communal field of view.

### BACKGROUND

Electronic devices are constantly changing and evolving to provide the user with flexibility and adaptability. With increasing adaptability in electronic devices users are taking and keep their devices on their person during various everyday activities. One example of a commonly used electronic device may be a head mounted display (HMD). Many HMDs may be used in artificial reality applications.

Artificial reality is a form of reality that has been adjusted in some manner before presentation to a user, which may include, for example, a virtual reality, an augmented reality, a mixed reality, a hybrid reality, or some combination or derivative thereof. Artificial reality content may include completely computer-generated content or computer-generated content combined with captured (e.g., real-world) content. The artificial reality content may include video, audio, haptic feedback, or some combination thereof, any of which may be presented in a single channel or in multiple channels (such as stereo video that produces a three-dimensional (3D) effect to the viewer). Additionally, in some instances, artificial reality may also be associated with applications, products, accessories, services, or some combination thereof, that are used to, for example, create content in an artificial reality or are otherwise used in (e.g., to perform activities in) an artificial reality. Head-mounted displays (HMDs) including one or more near-eye displays may often be used to present visual content to a user for use in artificial reality applications but may be heavy or used for short periods of time based on battery size and configuration.

Constantly having electronic devices, such as a HMD, on your person may lead to users wanting to record their everyday scenery, surroundings, or themselves. HMDs including one or more near-eye displays may often be used to present visual content to a user for use in artificial reality applications, but it may be heavy or used for short periods of time based on battery size and configured. Moreover, with the use of HMDs the image quality of the visual content presented to users, manufacturers and users may find image quality important.

### BRIEF SUMMARY

Methods and systems for adjusting device functions based on ambient conditions or battery status are disclosed. When environmental or device conditions reach a threshold level, device function such as display brightness or display refresh rate may be adjusted. The operation is associated with render rate of the content at the system on a chip or graphic processing unit of the device.

In an example, a method comprises testing one or more functions of a device; obtaining information associated with the device based on the testing of one or more functions of the device; and using the information to alter a subsequent operation of the device when the battery level is within a threshold level, an environmental condition, or when the device is in a critical environmental condition that warrants the system to shut down or throttle.

In an example, a method of adjusted device functions may include image fusion as image content changes field of view (FOV) from a wide camera or the outer portion of an image to the central portion of that same image. Conventionally a user may notice jitteriness, distortion, or disruption of the image resolution. These instances of jitteriness are especially apparent in videos as an object or person moves from the wide camera FOV to the narrow camera FOV, thus significantly altering the users viewing experience. To provide the optimal viewing experience for users, it would be imperative that when changing FOVs jitteriness may be avoided.

In an example, a method of image fusion may include receiving a first image from a wide camera and a second image form a narrow camera to create a composite image; referencing a memory to look up parameters of a transition zone; calculating a blending weight for spatial alignment; rendering a first image and a second image; computing adaptive weight to determine average intensity difference between the first image and the second image; determining whether to perform blending based on the referencing; and performing image blending sequence based on ratio of a blending weight and an adaptive weight.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The elements and features shown in the drawings are not necessarily to scale, emphasis instead may be being placed upon clearly illustrating the principles of the examples. Additionally, certain dimensions or positionings may be exaggerated to help visually convey such principles. Various examples of this invention will be described in detail, wherein like reference numerals designate corresponding parts throughout several views, wherein:

FIG. 1 is a plan view of a head-mounted display in accordance with an exemplary embodiment.

FIG. 2 is a flow chart of an exemplary method for throttling display brightness and refresh rate.

FIG. 3 may be an example image reflecting the wide camera FOV of a scene.

FIG. 4 may be an example image reflecting the narrow camera FOV of the scene.

FIG. 5 shows an example composite image obtained from both the wide and narrow camera FOVs of the scene.

FIG. 6A illustrates an exemplary view of the composite image with automatic region of interest tracking disclosed herein with a first region of interest position.

FIG. 6B illustrates an exemplary view of the composite image of FIG. 4 with a second region of interest position.

FIG. 6C illustrates an exemplary view of the composite image of FIG. 4 with a third region of interest position.

FIG. 7 illustrates an example host device 500 operable to perform multiple image fusion.

FIG. 8 illustrates a process flow chart for multiple image fusion of wide camera FOV and narrow camera FOV.

FIG. 9 illustrates an exemplary schematic diagram of the processes occurring during multiple image fusion.

FIG. 10A may be class diagram representing what the camera observes from its standing point.

FIG. 10B illustrates an exemplary view of the class diagram of FIG. 8A in a physical world.

FIG. 11 illustrates another exemplary class diagram of image fusion with the incorporation of the weights needed for fusion.

FIG. 12 illustrates the weight for intermediate/synthetic view in transition.

FIG. 13 illustrates sample adaptive weights as a function of Δ.

FIG. 14 illustrates an example of fusion outcome.

FIG. 15 illustrates an adjusting β for calibration errors due to module variation, assembling errors, and other types of spatial misalignment.

FIG. 16 illustrates a quadrilateral.

FIG. 17 illustrates the position weight from relative position of crop ROI and overlapped FOV.

The figures depict various embodiments for purposes of illustration only. One skilled in the art will readily recognize from the following discussion that alternative embodiments of the structures and methods illustrated herein may be employed without departing form the principles described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout.

It may be understood that the methods and systems described herein are not limited to specific methods, specific components, or to particular implementations. It also may be understood that the terminology used herein is for the purpose of describing particular embodiments only and is not intended to be limiting.

### A. Display Brightness and Refresh Rate Throttling Based on Ambient and System Temperature, and Battery Status

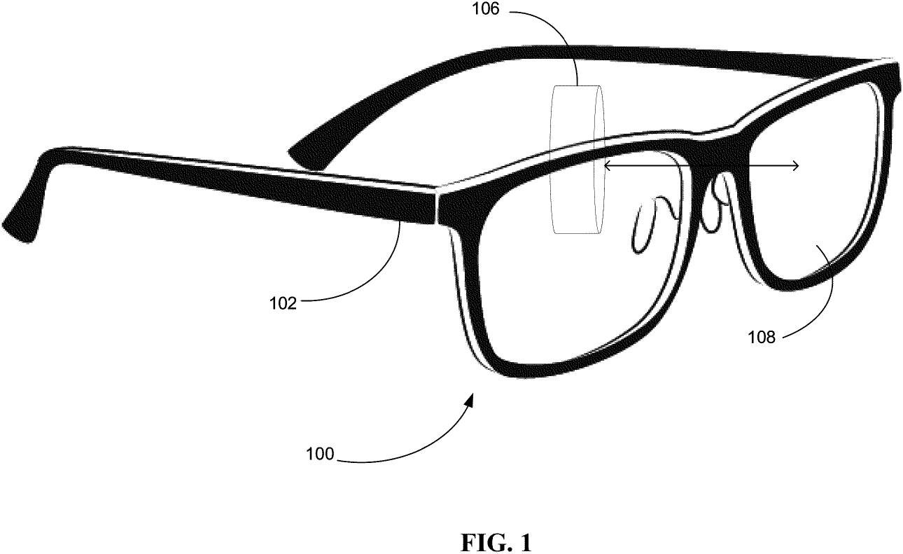

As shown in FIG. 1, HMD 100 including one or more near-eye displays may often be used to present visual content to a user for use in artificial reality applications. One type of near-eye display may include an enclosure 102 that houses components of the display or is configured to rest on the face of a user, such as for example a frame. The near-eye display may include a waveguide 108 that directs light from a light projector (not shown) to a location in front of the user’s eyes. Other display systems are contemplated herein.

Example devices in the present disclosure may include head-mounted displays 100 which may include an enclosure 102 with several subcomponents. Although HMD 100 may be used in the examples herein, it is contemplated that individual subcomponents of HMD 100 (e.g., waveguide, light projector, sensors, etc.), peripherals for HMD 100 (e.g., controllers), or hardware not related to HMD 100, may implement the disclosed authentication system. The present disclosure is generally directed to systems and methods for changing (e.g., throttling) device functions based on ambient conditions or battery status. In a first example scenario, display brightness may be altered based on battery condition or environmental conditions. An example scenario may include running an internal thermal model that uses temperature sensors on the device (e.g., a head temperature sensor) that will help determine if there should be throttling or not. As disclosed in more detail herein, based on the calibration data (which may initially be obtained at user startup of HMD 100, periodically during use of HMD 100, or at another period) in a lookup table (LUT) stored on HMD 100 (or remotely), display brightness may be adjusted lower to conserve or extend battery life of HMD 100. In a second example scenario, refresh rate may be adjusted when playing videos or viewing other applications to conserve or extend battery life of HMD 100. There’s an additional scenario where frame rate may be adjusted – when the wearer of HMD 100 transitions from a bright environment to a darker environment and dims the display. Under these transitions, the user’s sensitivity flicker sensitivity will change, and it may be power/thermal advantageous to change reduce the frame rate whenever possible. The lower the display content refresh rate (also referred herein as refresh rate), usually the lower the energy consumption. In some examples, there may separately be a refresh rate for the render, as well as a refresh rate for the display that is output to the eye by HMD 100. There are likely to be scenarios where one or both, depending on conditions, may be reduced.

FIG. 1 illustrates an example authentication system that include the use of a head-mounted display (HMD) 100 associated with artificial reality content. HMD 100 may include enclosure 102 (e.g., an eyeglass frame) or waveguide 108. Waveguide 108 may be configured to direct images to a user’s eye. In some examples, head-mounted display 100 may be implemented in the form of augmented-reality glasses. Accordingly, the waveguide 108 may be at least partially transparent to visible light to allow the user to view a real-world environment through the waveguide 108. FIG. 1 also shows a representation of an eye 106 that may be a real or an artificial eye-like object that is for testing or using HMD 100. Although HMD 100 is disclosed herein, the subject matter may be applicable to other wearables.

In HMD 100 (e.g., smart glasses product or other wearable devices), battery life and thermal management may be significant issues with regard to extending functionality while in use (e.g., throughout a day of wear by a user). The internal resistance in the small batteries inside wearable devices may increase significantly when the ambient temperature drops to cold temperatures, such as approximately 0° C. (C) to 10° C. When there are large current draws from the battery, the system may brown out due to the increased battery internal resistance. With the use of a display in HMD 100 (among other components), the power consumed and heat generated in the system may increase, therefore it may be beneficial to limit display content refresh rate (e.g., limit to 30 Hz from 60 Hz), reduce display brightness, or other functions of HMD 100 when the ambient temperature is too low (or high), when the system battery is running low, or when the surface temperatures reaches a threshold level (e.g., uncomfortable/unsafe), among other things.

Display brightness may be proportional to the current drive of the light source that may include light emitting diodes (LEDs). A calibration of output brightness against current drive may be performed on each HMD 100 system to create a look-up- table (LUT) (e.g., Table 1) which may be stored in an on-board nonvolatile memory of HMD 100. A pre-calibrated thermal LUT (e.g., Table 2) may also be stored in the on-board memory.

TABLE 1

Output Brightness to Current Drive LUT

| Current Drive (mA) | Brightness (nits) |
|---|---|
| 10 | 100 |
| 50 | 500 |
| 110 | 1000 |
| 230 | 2000 |
| 345 | 3000 |

TABLE 2

Thermal LUT

| Display Temperature (°C) | Brightness (nits) | Current Drive (mA) |
|---|---|---|
| 0 | 1000 | 110 |
| 10 | 2000 | 230 |
| 20 | 3000 | 345 |
| 30 | 3000 | 345 |
| 40 | 3000 | 345 |

A thermal LUT to change brightness. And then use Table 1 to look up new current values. These LUTs may then be used by a system on a chip (SOC) or the like of HMD 100 during display runtime to predict the power consumption of the display for each brightness value commanded by the software application directing content on the display. A budget for max power consumption and temperature may be stored in HMD 100. Operations, such as the output brightness, of HMD 100 may be scaled back (e.g., throttled) when the output brightness of the display exceeds LUT value(s) associated with the display power or thermal budget. In order to possibly help prevent system brownout, throttling may be applied to the display when the ambient temperature is at a threshold level or when the remaining battery level is below a threshold level.

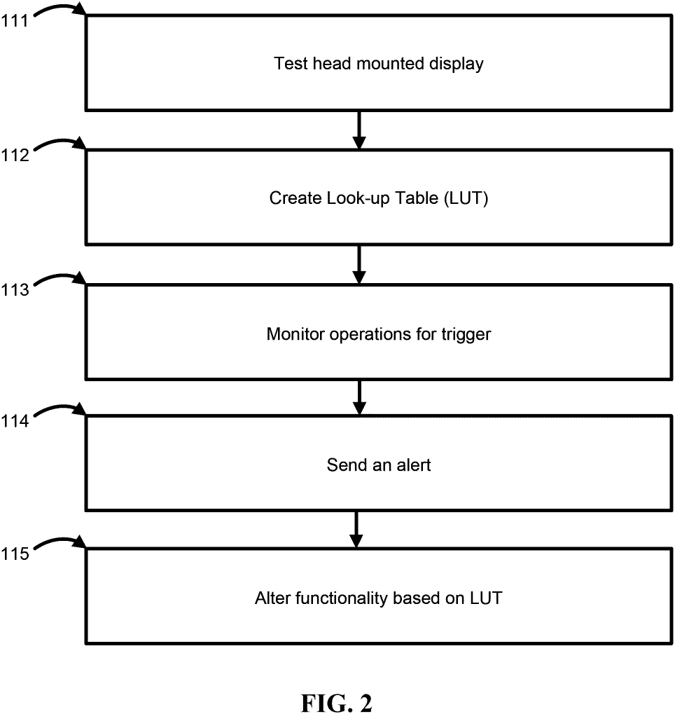

FIG. 2 illustrates an exemplary method for adjusting device functions based on ambient conditions or battery status.

At step 111, testing HMD 100 with regard to battery usage and HMD 100 functionality. For example, show a first test image (or other HMD 100 test function). Based on the first test image, record first battery usage, record first display brightness, or record first current used. The first display brightness may be measured based on captured images of an external camera directed toward HMD 100 lenses or other mechanism to measure brightness. The current or brightness may be altered to determine corresponding current levels, display brightness levels (or other functions), or battery usage levels for a particular HMD 100, which may be operating at particular ambient conditions (e.g., temperature, humidity, air quality, noise level, or intensity of light). HMD 100 functions may be associated with audio volume, wireless radio usage, camera captures, or other systems that consume power may be calibrated or throttled (not just display brightness), as disclosed herein.

At step 112, a LUT (or the like documentation) may be created and stored for each particular HMD 100 based on the tests. The LUT may be stored on HMD 100 indefinitely. Note that each test image (or other HMD 100 test function) may be categorized and then subsequent everyday use operational images (or operational functions) may be linked to a category. This will help make sure each operational function is treated in a way that corresponds to the determined thresholds. Table 3 illustrates an exemplary LUT for an image type 1 in which HMD 100 has a battery at 30% to 40% capacity.

TABLE 3

Image Type 1 at 30% -40% power

| | |
|---|---|
| Temperature | Display Brightness |
| 0° C. to 3° C. | Level 3 |
| 4° C. to 6° C. | Level 2 |
| 7° C. to 10° C. | Level 1 |

At step 113, the operations of HMD 100 may be monitored to determine when a threshold (a triggering event) has been reached (e.g., temperature threshold, battery percentage threshold, or functionality type threshold).

At step 114, when a threshold is reached, sending alert. The alert may be sent to the display of HMD 100 or to another internal system of HMD 100.

At step 115, based on the alert, altering the functionality of HMD 100 based on the LUT. Altering the functionality may include reducing display brightness or reducing current used to engage one or more functionalities of HMD 100, among other things.

Although HMD 100 is focused on herein, it is contemplated that other devices (e.g., wearables) may incorporate the disclosed subject matter.

The following design issues may be considered in relation to the maximum power savings to ensure there are minimal visual side effects associated with the disclosed methods, systems, or apparatuses.

With reference to a first design issue, reduced frame rates on the display of HMD 100 may potentially lead to undesirable visual artifacts like flicker, which is a measurable quantity. If the rendered frame rate is reduced, the display frame rate to the eye will be maintained at a minimum level by holding and repeating rendered frames from a buffer. Serving frames from a buffer may remove the visual artifacts associated with changing frame rates.

With reference to a second design issue, there may be variation in each manufactured HMD 100, because of the unit-to-unit variations (e.g., based on manufacturing precision and statistical properties of hardware components), there may be unit to unit calibration (e.g., testing and individualized unit LUTs), as disclosed herein. Therefore, there may be a quantity calibrated for the display power budget, which may be based on the hardware or other components present in HMD 100.

A user may be notified by the HMD 100 that throttling is happening and what mitigations the user may take (e.g., charge, take a pause, move to a warmer place, etc.) to regain full functionality.

### B. Multi- View Image Fusion

With the growing importance of camera performance to electronic device manufacturers and users, manufacturers have worked through many design options to improve image quality. One common design option may be the use of a dual-camera system. In a dual camera system, an electronic device may house two cameras that have two image sensors and are operated simultaneously to capture an image. The lens and sensor combination of each camera within the dual camera system may be aligned to capture an image or video of the same scene, but with two different FOVs.

Many electronic devices today utilize dual aperture zoom cameras in which one camera has a wider field of view (FOV) than the other. For example, one dual camera system may use a camera with a ultra-wide FOV and a camera with a narrower FOV, which may be known as a wide camera or tele camera. Most dual camera systems refer to the wider FOV camera as a wide camera and the narrower FOV camera as a tele camera. The respective sensors of each camera, where the wide camera image has lower spatial resolution than the narrow camera video/image. The images from both cameras are typically merged to form a composite image. The central portion of the composite image may be composed of the combination of the relatively higher spatial resolution image from the narrow camera with the view of the tele camera. The outer view of the image may be comprised of the lower resolution FOV of the wide camera. The user can select a desired amount of zoom and the composite image may be used to intercalate values from the chosen amount of zoom to provide a respective zoom image. As the image content changes FOV from the wide camera or the outer portion of an image to the central portion of that same image, a user may notice jitteriness, distortion, or disruption of the image resolution. These instances of jitteriness may be especially apparent in videos as an object or person moves from the wide camera FOV 104 to the narrow camera FOV 106, thus significantly altering the users viewing experience. Although an image may be discussed herein, the use of a video may be contemplated.

The present disclosure may be generally directed to systems and methods for multiple camera image fusion. Examples in the present disclosure may include dual camera systems for obtaining high resolution while recording videos and capturing images. A dual camera system may be configured to fuse multiple images during motion to blend camera field of views.

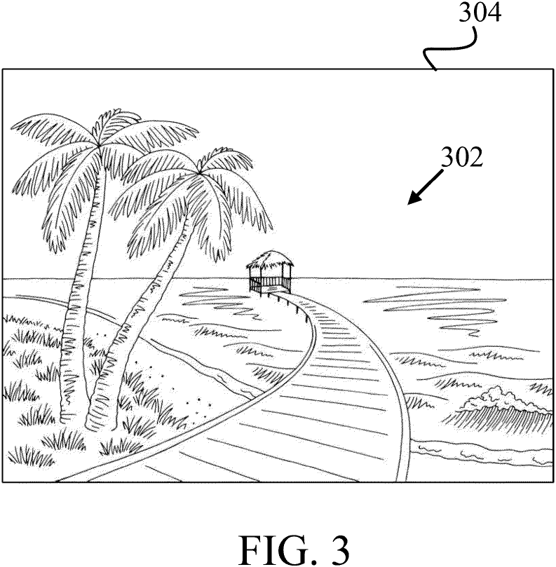

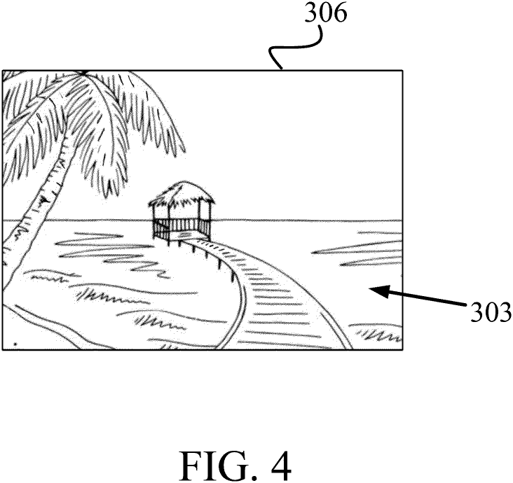

FIG. 3 shows an exemplary image of a scene or frame of a video, 304 reflecting the wide camera FOV of a scene 302. Herein, the wide camera may be any camera lens capturing a FOV. FIG. 4 shows an exemplary image of a scene or frame of a video, 306 reflecting the narrow camera FOV of scene 303, a portion of the scene 302 of FIG. 3. Herein, the narrow camera may be any camera lens that captures a FOV at a higher resolution than the wide camera. The scenes obtained from the wide and narrow camera are captured simultaneously with a dual camera system. For example, the two cameras may be two back cameras of a smartphone or any communication device including two cameras with a shared field of view.

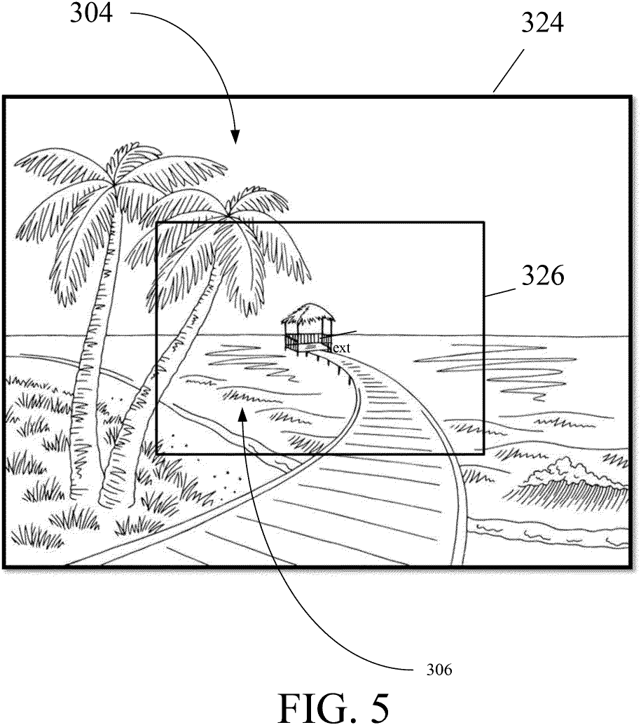

FIG. 5 shows an exemplary scene 324 identical with the wide camera FOV 304 reflecting a scene 302 as seen in FIG. 1. FIG. 5 further comprises a frame 326 that indicates the position of the narrow camera FOV 306. The camera may present a user with a high-resolution image by blending the narrow camera FOV 306 with the wide camera FOV 304 or by sole use of the narrow camera FOV 306. The position of the narrow image FOV 306 that may be centric to the wide image FOV 304 may be called a “zero” position of the narrow image FOV 306.

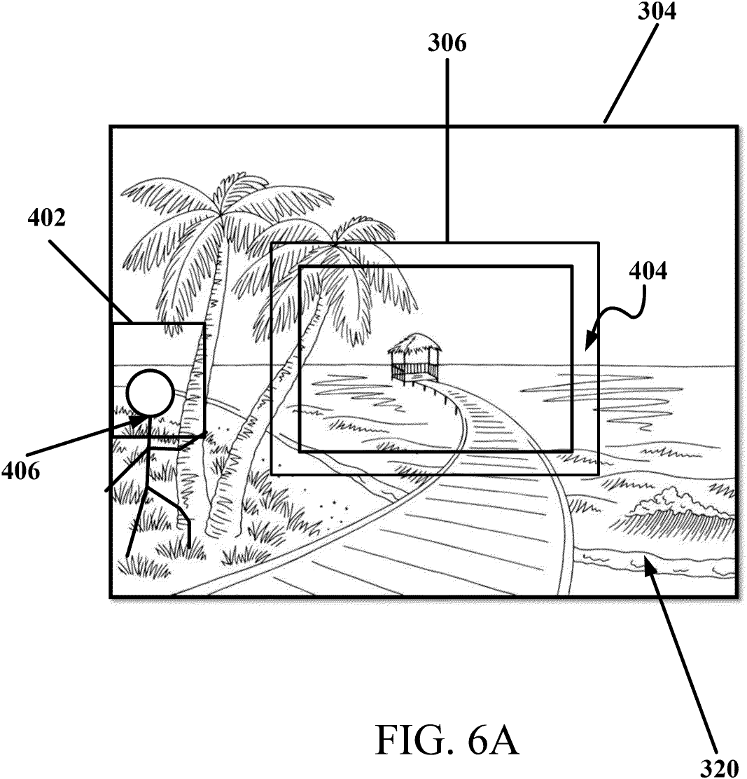

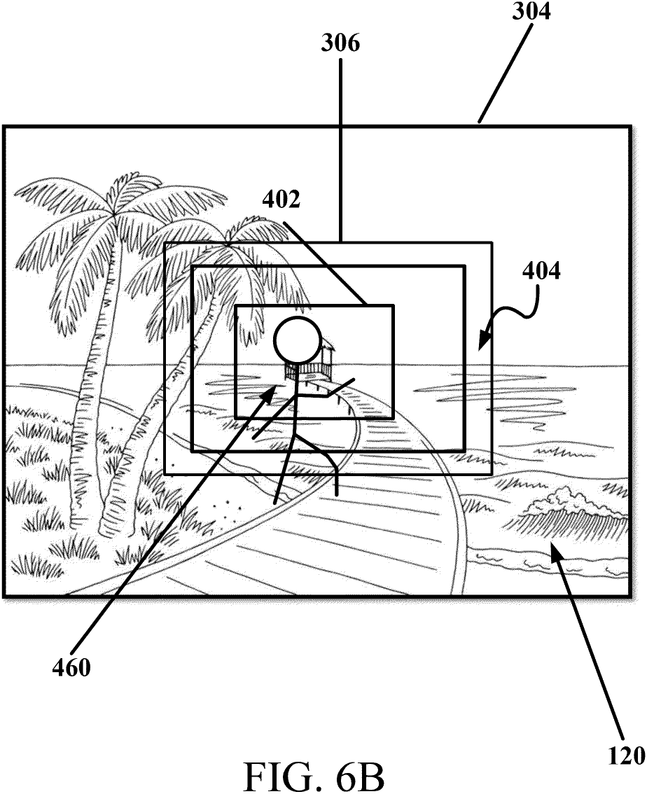

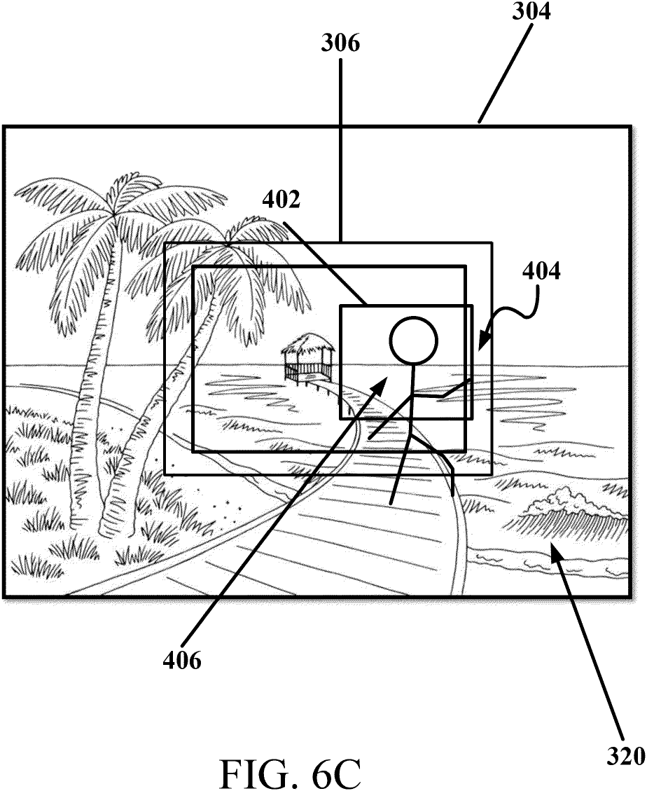

FIG. 6A shows an exemplary scene 320 incorporating a dual camera system that automatic region of interest tracking disclosed herein with a first region of interest 402 positioned outside of the narrow camera FOV 306 and within the wide camera FOV 304. FIG. 6B shows a scene of FIG. 6A with a second region of interest 402 positioned within the narrow camera 306. FIG. 6C shows a scene of FIG. 6A with a third region of interest positioned within a transition zone 404. In each of these FIGS. the region of interest 402 includes a person 406 walking. The decision to track the person may be taken automatically by a computing device (e.g., host device 500) associated with a camera. The computing device may include a phone, a stand-alone camera, or a remote serve communicatively connected with the camera.

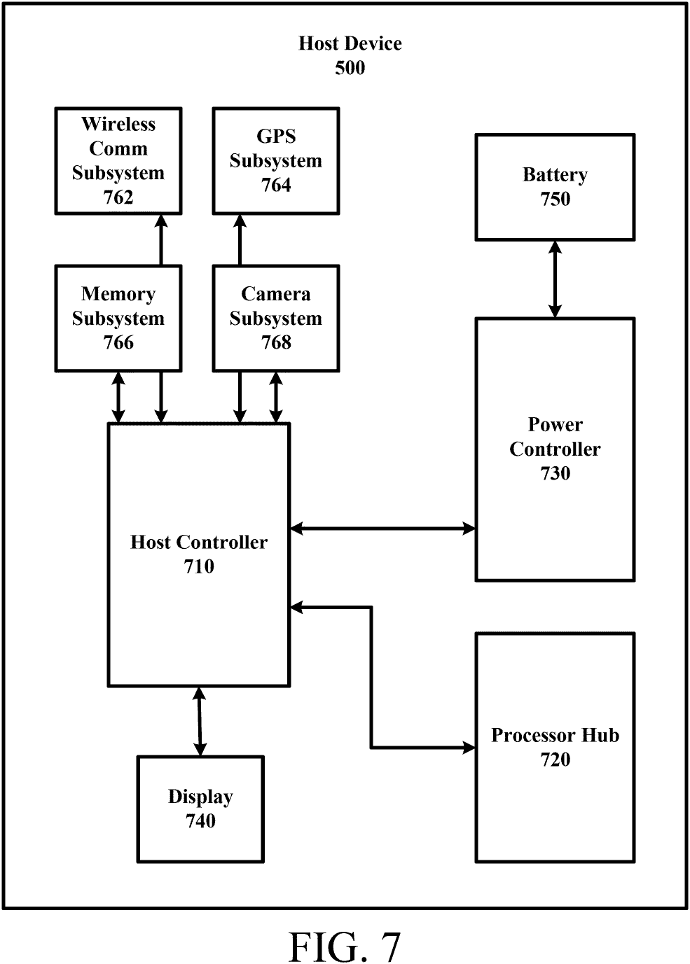

The region of interest 402 value may be determined by a host device 500 as seen in FIG. 7, image pixel values, and metadata such as disparity map or confidence map. The disparity map may be a de facto warp map to project the current image view to the composite view 324. Disparity map refers to the apparent pixel difference or motion between a pair of stereo images. Whereas the confidence map may be for masking. The confidence map may be a probability density function on the new image, assigning each pixel of the new image a probability, which may be the probability of the pixel color occurring in the object in the previous image.

Images and videos may be captured from both the wide and narrow camera or solely by the wide camera or the narrow camera during automatic tracking of the region of interest and blended to form a composite image or composite video. The blending may be applied on the dual camera system hosting device simultaneously as an image is taken. In each composite image as the region of interest encroaches the narrow camera FOV, the region of interest enters the transition zone initiating a blending sequence of the narrow camera FOV 306 and wide camera FOV 304. The parameters of the transition zone reference a memory 766 on the host device 500 to determine the blending of each FOV narrow and wide may be used to obtain optimal viewing resolution, so one may overcome motion while retaining optimal viewing experience.

FIG. 7 illustrates an example host device 500 operable to perform multiple image fusion. Elements of host device 500 include a host controller 710, at least one processor in the processor hub 720, power controller 730, display 740, or a battery 750. The host device 500 also includes several subsystems such as a wireless comm subsystem 762, GPS subsystem 764, memory subsystem 766, or a camera subsystem 768. The components of host device 500 may be communicatively connected with each other.

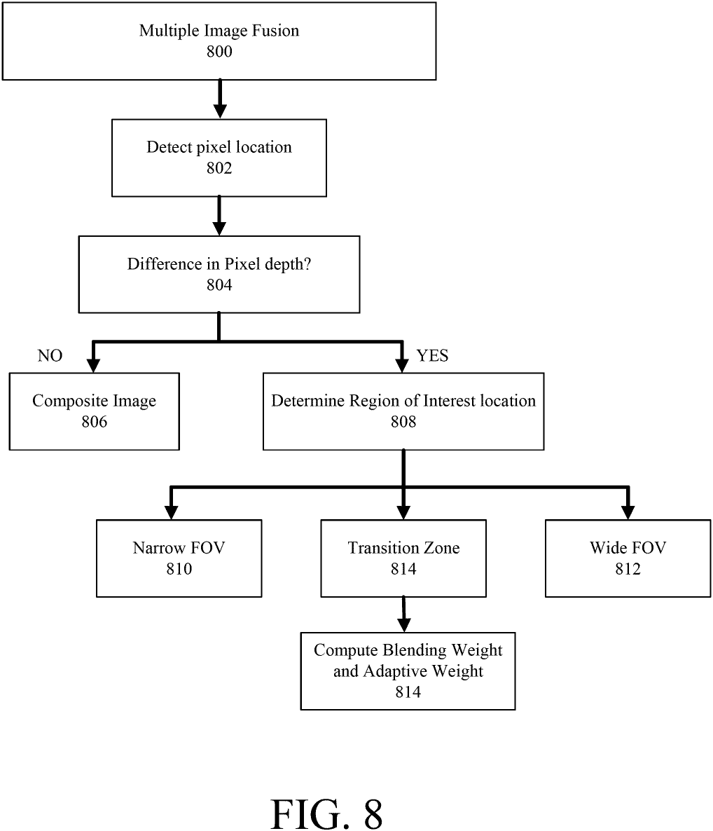

FIG. 8 illustrates an exemplary process flow chart for multiple image fusion sequence 800 between two cameras. At block 802, the pixel locations are detected as performed by processor 404. For example, one or more processors 404 may determine the pixel locations of scene 302 and undergo a disparity mapping a process described above.

At block 804, the difference in pixel depth may be determined between narrow camera FOV 306 and wide camera FOV 304. For example, one or more processors may undergo confidence mapping to determine the difference in pixel depth between the wide camera FOV 304 and the narrow camera FOV 306. If a difference in pixel depth may not be determined the sequence may end at block 806.

At block 806, the image may be rendered as a composite image 324 as shown in FIG. 5 with both the wide camera FOV 304 and the narrow camera FOV 306. Thus, no blending occurs between the wide camera FOV 304 and the narrow camera FOV 306.

At block 808, the region of interest location may be determined. For example, processor 404 may determine a change in density within the image and then spatially align the pixel signals of the two images received from the wide camera FOV 304 and the narrow camera FOV 306. The one or more processors 404 may be capable of determining a region of interest given the disparity map, confidence map, and pixel alignment.

At block 910 and block 912, the decision whether to present an image with the narrow camera FOV 306 and the wide camera FOV 304 based on the location of the region of interest may be determined. For example, at the block 910, when the region of interest may be determined to be outside of the narrow camera FOV 306, the dual camera system may utilize the wide camera FOV 304 to show a scene 302. At the block 912, the region of interest may be determined to be inside the narrow camera FOV 306, the dual camera system may utilize only the narrow camera FOV 304 to show a portion of a scene 303. Thus, for both examples mentioned above image fusion or blending may not occur.

At block 914, a memory may be referenced to determine the transition zone 404 based on the host devices 500 settings and requirements. At block 916, a blending weight and adaptive weight may be computed. The one or more processors 404 may then compute the blending weight and the adaptive weight. Once the weights are determined the rate at which blending occurs may be evaluated as the region of interest moves from a FOV to another FOV. Although two processors are discussed herein, it may be contemplated that one processor may perform the method, if needed.

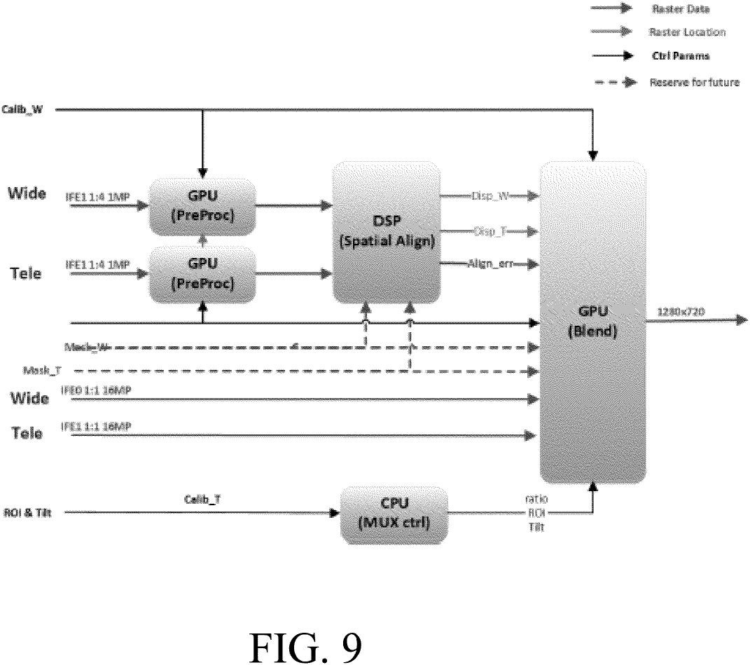

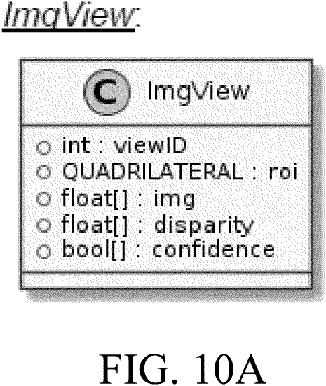

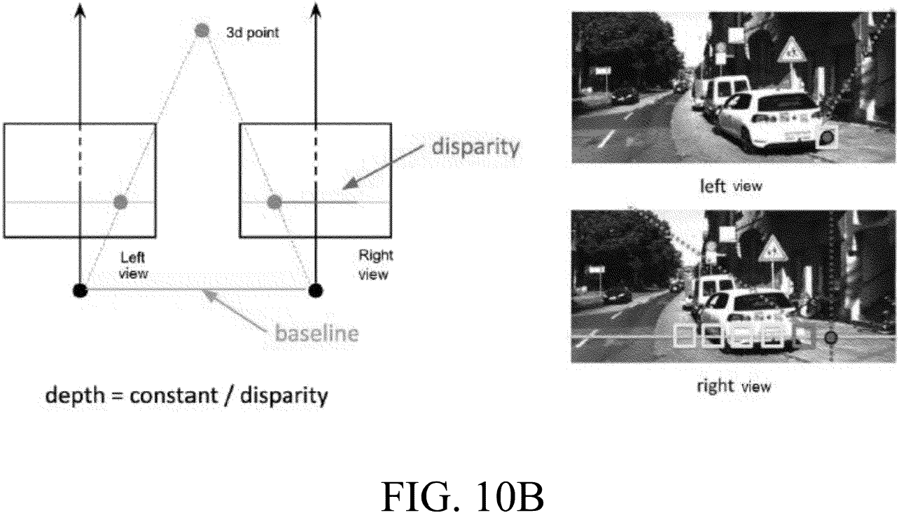

FIGS. 9, 10A, 10B, 11, 12, 13 and 14 are utilized to provide further detail in the relevant subject matter such as how the weights may be calculated. FIG. 9 illustrates an exemplary schematic diagram of the processes occurring during multiple image fusion. FIG. 10A may be a class diagram representing what the camera may observe from its standing point, as depicted in FIG. 10B. Each view class comprises an identification, a region of interest to operate within, whose value may be from apps crop tag, image pixel values, and metadata such as disparity map, or confidence map. The disparity map may be a de facto warp map to project the current image view to the other view. Confidence map may be for masking. One example of usage may be to indicate skipping areas and reusing previous results.

Projection type may not be a class member of ImgView, for that the instance of view may be transformed into multiple types of projections, also because projection may be closely related to coordinate mapping which may be handled in Mapper class. In FIG. 10B may be the ImgView of FIG. 10A in a physical world.

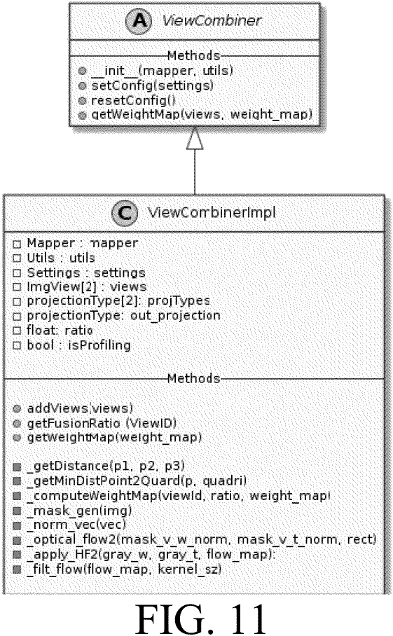

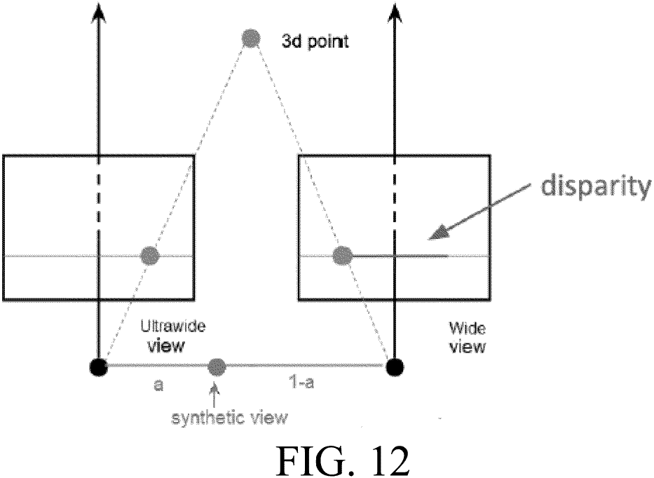

FIG. 11 illustrates another exemplary class diagram of image fusion with the incorporation of the weights needed for fusion. There are two types of weights calculated in this image fusion. The first type or a blended weight may be derived from the position of intermediate view with respect to wide view as the pivot. At the beginning of the transition where the point of view may be close to the wide camera, a is close to 1.0. As the intermediate view transits to the right/narrow view, a’s value diminishes and ends at 0.0. The frame content of the intermediate view follows the same pattern, e.g., most may be from wide content initially and then dampened. This means it may create a visual effect of smoothly sliding from one view to the other, especially effective for fusion over narrow baseline where sudden viewing angle change likely causes unnatural user experience. It also may help to create a smooth transition for objects both in the work zone and in near or middle range. In an example, objects may move from far to near distances but stay in the center of both views. FIG. 12 illustrates the weight a for intermediate/synthetic view in transition.

Formulas (1) - (3) below describe the process of view position fusion, where Iᵤₗₜᵣₐ and I_{wide} denote wide rectified input images of wide and narrow view, d (x, y)is the disparity map, Îᵤₗₜᵣₐ and Î_{wide} are the warped input images in which the warping strength may be determined by a*d (x, y), and Iₒᵤₜ represents the fused output image. As one can see the weighting may not be carried out at pixel value but also pixel locations. The mechanism of calculating weight a may be explained in the section of quadrilateral class.

$${\hat{I}}_{u l t r a} \left(x , y\right) = {I}_{u l t r a} \left(x + a ∗ d \left(x , y\right) , y\right) \qquad \text{(1)}$$

$${\hat{I}}_{w i d e} \left(x , y\right) = {I}_{w i d e} \left(x + \left(1.0 - a\right) ∗ d \left(x , y\right) , y\right) \qquad \text{(2)}$$

$${I}_{o u t} = a ∗ {\hat{I}}_{u l t r a} + \left(1.0 - a\right) ∗ {\hat{I}}_{w i d e} \qquad \text{(3)}$$

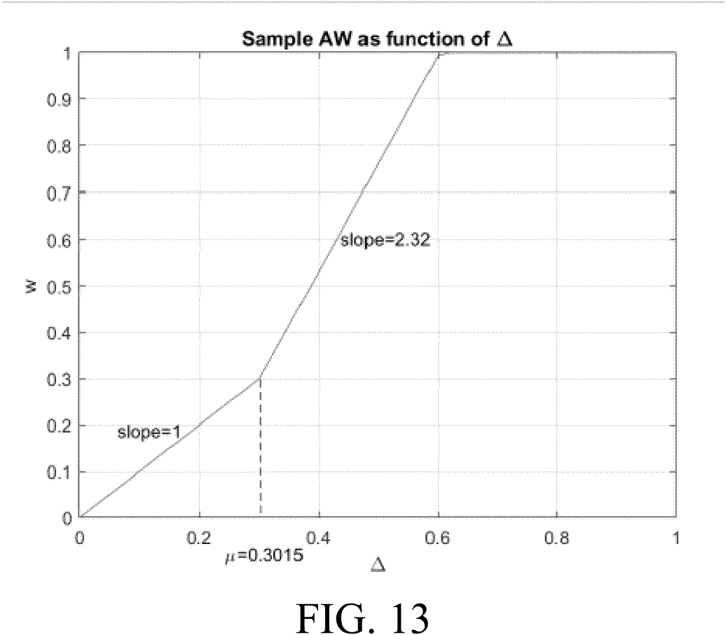

The second type of weighting may be adaptive weighting. Its value varies pixel by pixel, jointly determined by µ, the averaged intensity differences between Gaussian blurred image pair, as well as Δ, the pixel gap of the local pair. G(·)is the Gaussian blur operation. When Δ is small, as shown in the range from [0, µ] in FIG. 13, it indicates that the vicinity pairs are spatially well aligned. Since in Hines the wide camera usually carries richer information. The value of weights may be small as well, meaning the wide view content may be more favored. FIG. 13 illustrates sample adaptive weights as a function of Δ.

$$Δ = \left|G \left({\hat{I}}_{u l t r a}\right) - G \left({\hat{I}}_{w i d e}\right)\right| \qquad \text{(4)}$$

$$μ = \overline{Δ} \qquad \text{(5)}$$

$$w = \left\{β \left(\frac{2}{{e}^{μ} - {e}^{- μ}}\right) ∗ Δ + \left(\frac{2 β}{{e}^{μ} + {e}^{- μ}} - 1\right) μ , ∀ Δ \geq μ\right) \qquad \text{(6)}$$

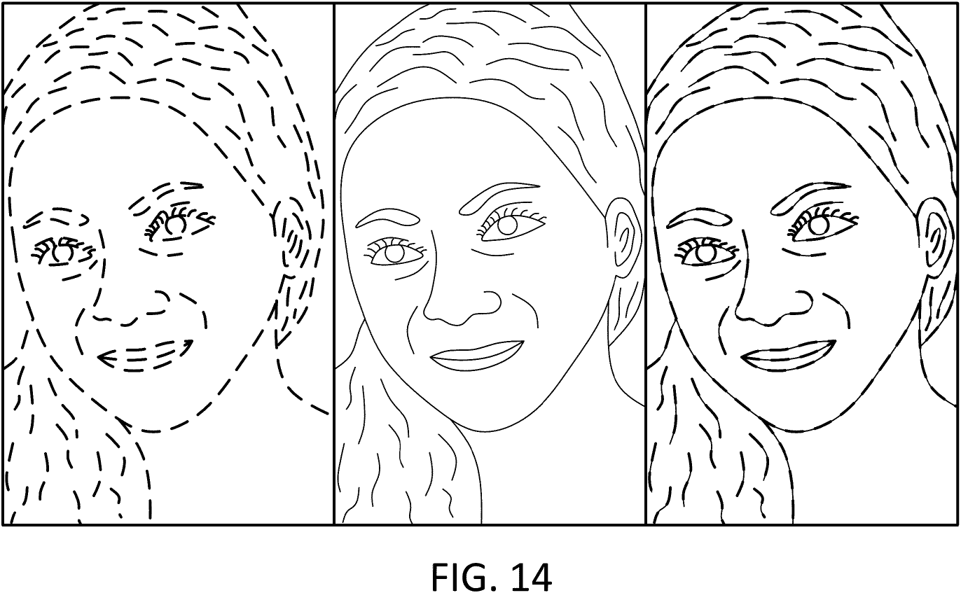

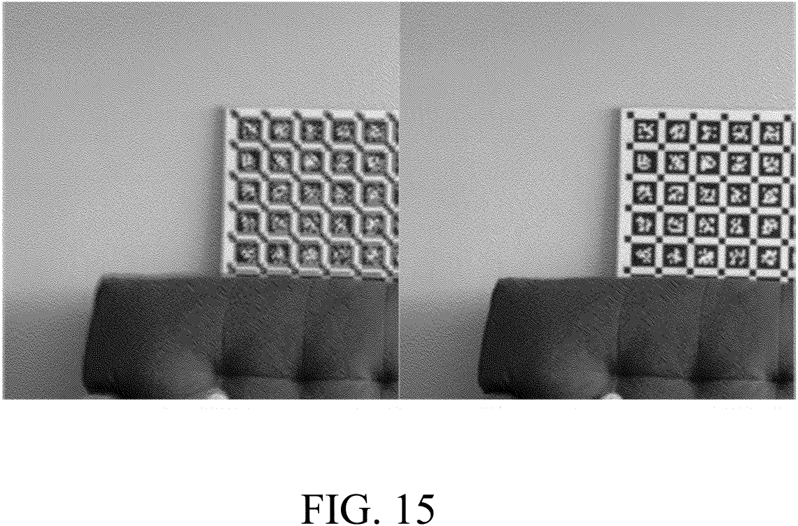

FIG. 14 illustrates an example of fusion outcome. From synthetic data form left to right, wide view, narrow view, or fused view with a = 0.0 with adaptive weighting. If Δ is beyond the small range, as illustrated in the middle segment in FIG. 14, it indicates a local misalignment. The error may come from calibration error, or module variation in per-batch calibration. Ghosting may be observed as the consequence of this type of spatial misalignment, as depicted in the left picture in FIG. 15. β ranging from 1 to 15 may be the tuning parameter that may be adjusted to suppress the artifacts. The right picture in FIG. 15 shows an example of improvement after increasing β. Whereas FIG. 15 illustrates an adjusting β for calibration errors due to module variation, assembling errors, and other types of spatial misalignment.

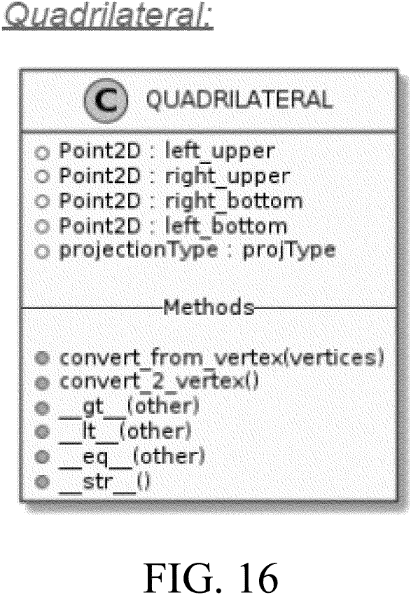

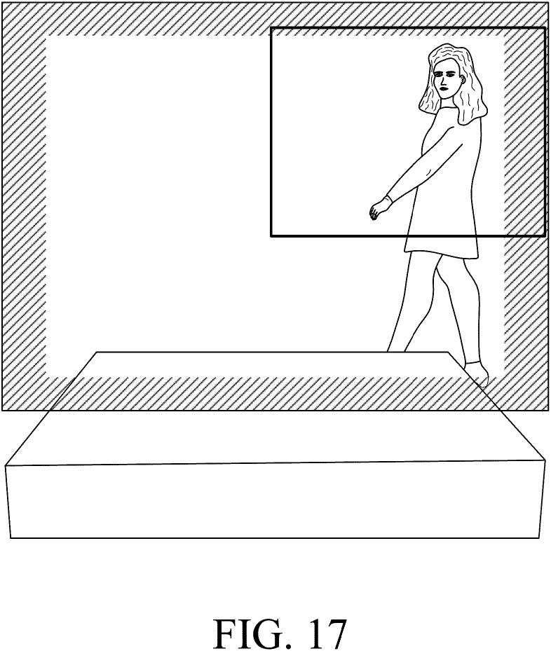

FIG. 16 illustrates a quadrilateral. The quadrilateral may be used to determine the relative position of the cropped region of interest, the area that viewers can see as the ultimate output of the camera pipeline, denoted in red rectangle in FIG. 17, and fixed overlapped region across the dual camera, the blue colored rectangle. When cropped ROI may not be fully encompassed by the blue overlapped FOV, the content of the first view may be 100% selected. On the flip side, if cropped ROI fully resides inside the inner blue region, i.e., overlapped FOV + buffering region for image fusion, the second/narrow view which normally carries the higher IQ may be 100% selected. Anywhere in between the image fusion algorithm may be called whenever any edge of the cropped ROI (in red) locates inside the blue shaded area and stops when it exits. The fusion weights are dynamically adjusted based on the closest distance between red edge and blue edges. This strategy provides an economic way to seamlessly transit from view0 to view1 when viewing interest regions shifts from close/middle-field objects to far-field objects and vice versa. FIG. 17 illustrates the position weight from relative position of crop ROI and overlapped FOV.

The foregoing description of the embodiments has been presented for the purpose of illustration; it is not intended to be exhaustive or to limit the patent rights to the precise forms disclosed. Persons skilled in the relevant art may appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which may be executed by a computer processor for performing any or all of the steps, operations, or processes described.

Embodiments also may relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

What is claimed:

1. A method comprising:
testing one or more functions of a device;
obtaining information associated with the device based on the testing of one or more functions of the device; and
using the information to alter a subsequent operation of the device when battery level is within a threshold level or an environmental condition.

2. The method of claim 1, wherein the device is a virtual reality or augmented reality related wearable device.

3. The method of claim 1, wherein the environmental condition is associated with the device.

4. The method of claim 1, wherein the environmental condition is associated with a battery of the device.

5. The method of claim 1, wherein the operation is associated with display brightness of the device.

6. The method of claim 1, wherein the operation is associated with display refresh rate of the device.

7. The method of claim 1, wherein the operation is associated with render rate of content at a system on a chip or graphic processing unit of the device.

8. The method of claim 1, wherein the environmental condition comprises ambient temperature.

9. The method of claim 1, wherein the environmental condition comprises ambient brightness.

10. A device for seamless multi-view image fusion comprising:
one or more processors; and
memory coupled with the one or more processors, the memory storing executable instructions that when executed by the one or more processors cause the one or more processors to effectuate operations comprising:
receiving parameters associated with a transition zone;
calculating a blending weight for spatial alignment;
rendering a first image and a second image, wherein both the first image and the second image comprises an object;
computing adaptive weight to determine average intensity difference between the first image and the second image;
determining whether to perform blending based on the parameters; and
performing image blending sequence based on ratio of the blending weight and an adaptive weight.

11. The device of claim 10, further comprises a user interface coupled to a screen configured to display at least one image acquired with at least one of a narrow camera and a wide camera.

12. The device of claim 11, wherein the wide camera is configured to provide the first image with a first resolution, wherein the wide camera comprises a wide image sensor and a wide lens with a wide field of view, wherein the first image comprises the object.

13. The device of claim 11, wherein the narrow camera is configured to provide the second image with a second resolution, wherein the narrow camera comprises a narrow image sensor and a narrow lens with a narrow field of view, wherein the second image comprises a portion of the object with higher resolution than the first image.

14. The device of claim 10, wherein the device is configured to display a frame defining a narrow field of view within a wide field of view, wherein the wide field of view bounds the narrow field of view.

15. The device of claim 10, wherein the one or more processors are configured to perform autonomous region of interest tracking.

16. The device of claim 11, wherein the device is configured to fuse the first image, captured via the wide camera, with the second image, captured via the narrow camera, to create a composite image, wherein the composite image comprises the object.

17. The device of claim 10, wherein the transition zone is operable to determine whether to begin blending, wherein the transition zone is determined by a user or device settings.

18. The device of claim 16, wherein the transition zone determines what percentage of the first image and the second image are used to configure the composite image.

19. A method of seamless multi-view image fusion comprising;
referencing a memory to look up parameters of a transition zone;
calculating a blending weight for spatial alignment;
rendering a first image and a second image;
computing adaptive weight to determine average intensity difference between the first image and the second image;
determining whether to perform blending based on the referencing; and
performing image blending sequence based on ratio of the blending weight and an adaptive weight.

20. The method of claim 19, wherein the performing further comprises determining a ratio of the blending weight and the adaptive weight.
